(19) United States
(12) Patent Application Publication
(10) Pub. No.: US 2016/0280887 A1
(43) Pub. Date: Sep. 29, 2016

(54) RESIN COMPOSITION AND RESIN MOLDED ARTICLE

(71) Applicant: FUJI XEROX CO., LTD., Tokyo (JP)

(72) Inventors: Masahiro MORIYAMA, Kanagawa (JP); Kenji YAO, Kanagawa (JP); Hisae YOSHIZAWA, Kanagawa (JP); Ryo TANAKA, Kanagawa (JP)

(21) Appl. No.: 14/824,331

(22) Filed: Aug. 12, 2015

(30) Foreign Application Priority Data
Mar. 26, 2015 (JP) 2015-064765

(51) Int. Cl. C08K 5/521; C08K 5/10; C08K 5/098; C08K 5/11

(52) U.S. Cl. CPC C08K 5/521; C08K 5/11; C08K 5/10; C08K 5/098

(57) ABSTRACT

A resin composition contains a cellulose derivative of which a weight average molecular weight is 10,000 or greater and less than 75,000 and in which at least one hydroxyl group is substituted with an acyl group having 1 to 6 carbon atoms; and a plasticizer.

### CROSS-REFERENCE TO RELATED APPLICATIONS

This application is based on and claims priority under 35 USC 119 from Japanese Patent Application No. 2015-064765 filed Mar. 26, 2015.

### BACKGROUND

1. Technical Field

The present invention relates to a resin composition and a resin molded article.

2. Related Art

In the related art, various resin compositions are provided to be used for various applications. Particularly, thermoplastic resins are used in various components and housings of home appliances or automobiles, or in components such as housings of business machines and electric and electronic apparatuses.

Recently, resins derived from plants are used, and a cellulose derivative is one of the resins derived from plants which are well-known from the past. In addition, in view of imparting fluidity to the cellulose derivative, addition of a plasticizer has been attempted.

### SUMMARY

According to an aspect of the invention, there is provided a resin composition containing:

a cellulose derivative of which a weight average molecular weight is 10,000 or greater and less than 75,000, and in which at least one hydroxyl group is substituted with an acyl group having 1 to 6 carbon atoms; and

a plasticizer.

### DETAILED DESCRIPTION

Hereinafter, embodiments which are examples of a resin composition and a resin molded article according to the invention are described.

Resin Composition

The resin composition according to the exemplary embodiment contains a cellulose derivative and a plasticizer.

The cellulose derivative is a cellulose derivative (hereinafter, collectively referred to as “specific cellulose derivative”) of which a weight average molecular weight is 10,000 or greater and less than 75,000, and in which at least one hydroxyl group is substituted with an acyl group having 1 to 6 carbon atoms.

In view of imparting plasticity to the cellulose derivative when processing is performed, a plasticizer may be mixed to be used. However, there are cases where the plasticizer mixed with the cellulose derivative causes bleed-out (a phenomenon in which the plasticizer oozes on the surface) on the surface after a resin molded article is formed. In addition, when the environment in which the resin molded article is stored is very hot and humid, the bleed-out of the plasticizer is easily generated.

Therefore, it is required to prevent the bleed-out of the plasticizer while workability such as kneading performances or molding performances is enhanced.

Meanwhile, since the resin composition according to the exemplary embodiment contains the specific cellulose derivative in which at least one hydroxyl group is substituted with an acyl group having 1 to 6 carbon atoms and a weight average molecular weight is 10,000 or greater and less than 75,000, and a plasticizer, the bleed-out of the plasticizer is prevented.

The main reason of the effect is not clear, but it is assumed as follows.

It is considered that the reason is that the molecular weight of the cellulose derivative is in a range less than the upper limit, that is, lower than that of a general cellulose derivative, and thus the plasticizer easily enters cellulose fibrils. As a result, it is assumed that the plasticizer is retained by the cellulose derivative, and thus the bleed-out is prevented.

In addition, as the molecular weight of the cellulose derivative is reduced, the number of terminals of a molecular chain is relatively increased, and thus the number of hydroxyl groups existing in the terminals is increased. Therefore, hydrogen bonds formed between the hydroxyl groups at the terminals after molding is performed are also increased. It is assumed that, in association with the increase of the hydrogen bond, the interaction with the plasticizer is also increased, and as a result, the plasticizer is unlikely to deposit to thereby prevent the bleed-out.

Also, it is assumed that since the molecular weight of the cellulose derivative is in a range greater than the lower limit, the retention of the plasticizer in the cellulose derivative is satisfactorily exhibited, and the plasticizer is retained in the cellulose derivative, such that the bleed-out is prevented.

In addition, with the resin composition according to the exemplary embodiment, the resin molded article having a high elastic modulus can be obtained. Also, thermal fluidity and heat resistance are also excellent.

Generally, in a resin, the strength tends to be low as the molecular weight becomes lower, but in the cellulose derivative, as the molecular weight becomes small, the number of terminals of the molecular chain relatively increases, and thus the number of hydroxyl groups existing in the terminals increases. Therefore, after molding is performed, hydrogen bonds are formed between hydroxyl groups at the terminals, hydrogen bonding strength becomes high, and thus an elastic modulus is enhanced. In addition, it is considered that, according to the influence of the hydrogen bonding strength, excellent heat resistance is also obtained.

In addition, when thermofusion is performed, the hydrogen bond between the terminals becomes weak. Therefore, according to the cellulose derivative having a molecular weight falling within the range described above, the viscosity is decreased, the thermal fluidity is increased, and thus the moldability is enhanced.

In addition, since the cellulose derivative plasticized by adding the plasticizer is more satisfactorily dispersed in the resin composition, the plasticization effect is more enhanced, and as a result, the thermal fluidity is more enhanced, such that the moldability becomes more excellent.

Hereinafter, components of the resin composition are described in detail.

Cellulose Derivatives

Weight Average Molecular Weight

In the specific cellulose derivative used in the exemplary embodiment, the weight average molecular weight is 10,000 or greater and less than 75,000. The weight average molecular weight is more preferably in the range of 20,000 to 50,000.

If the weight average molecular weight is 75,000 or greater, the effect of preventing bleed-out of the plasticizer when the resin molded article is formed is decreased. In addition, if the weight average molecular weight is 10,000 or less, the effect of preventing the bleed-out of the plasticizer when the resin molded article is formed is decreased, and the molecular weight becomes too low. Therefore, the elastic modulus and the heat resistance are also decreased.

Here, the weight average molecular weight (Mw) is a value measured by gel permeation chromatography (GPC). Specifically, the molecular weight by GPC is measured with a GPC apparatus (manufactured by Tosoh corporation, HLC-8320GPC, Column: TSKgel α-M) by using a solution of dimethylacetamide/lithium chloride having a volume ratio of 90/10.

Structures

Specifically, as the specific cellulose derivative, for example, the cellulose derivative represented by the formula (1) is exemplified.

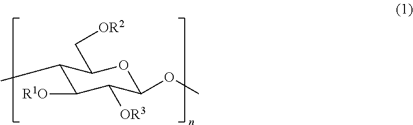

In the formula (1), R¹, R², and R³ each independently represent a hydrogen atom and an acyl group having 1 to 6 carbon atoms. n represents an integer of 2 or greater. However, at least one of plural R¹s, plural R²s, and plural R³s represents an acyl group having 1 to 6 carbon atoms.

In the formula (1), n is not particularly limited, but preferably in the range of 40 to 300, and more preferably in the range of 100 to 200.

If n is 40 or greater, the strength of the resin molded article is easily increased. If n is 300 or lower, the decrease of flexibility of the resin molded article is easily prevented.

Acyl Group

In the specific cellulose derivative used in the exemplary embodiment, at least one hydroxyl group is substituted with an acyl group having 1 to 6 carbon atoms. That is, if the cellulose derivative has a structure represented by the formula (1), at least one of plural R¹s, plural R²s, and plural R³s represents an acyl group having 1 to 6 carbon atoms.

Therefore, plural R¹s in the cellulose derivative represented by the formula (1) may be identical to each other, or may be different from each other. In the same manner, plural R²s may be identical to each other or may be different from each other, and plural R³s may be identical to each other or may be different from each other. At least one of plural R¹s, plural R²s and plural R³s represents an acyl group having 1 to 6 carbon atoms.

If all acyl groups substituted in the cellulose derivative are those having 7 or more carbon atoms, not only an elastic modulus but also the heat resistance is decreased.

The number of carbon atoms of the acyl group substituted in the specific cellulose derivative is preferably in the range of 1 to 4, and more preferably in the range of 1 to 3.

The acyl group having 1 to 6 carbon atoms is represented by a structure of “—CO—R_{AC}”, and “R_{AC}” represents a hydrogen atom or a hydrocarbon group having 1 to 5 carbon atoms.

The hydrocarbon group represented by “R_{AC}” may have any one of a straight chain shape, a branched shape, or a cyclic shape, but preferably a straight chain shape.

In addition, the hydrocarbon group may be a saturated hydrocarbon group or an unsaturated hydrocarbon group, but preferably a saturated hydrocarbon group.

In addition, the hydrocarbon group may contain other atoms except for carbon or hydrogen (for example, oxygen or nitrogen), but preferably a hydrocarbon group made of only carbon and hydrogen.

As the acyl group having 1 to 6 carbon atoms, a formyl group, an acetyl group, a propionyl group, a butyryl group (butanoyl group), a propenoyl group, a hexanoyl group, and the like are included.

Among them, as an acyl group, in view of the enhancement of the elastic modulus and the heat resistance and the enhancement of the moldability of the resin composition, an acetyl group is preferable.

Substitution Degree

A substitution degree of a specific cellulose derivative is preferably 2.5 or lower. If the substitution degree is 2.5 or lower, the number of hydroxyl groups included in the cellulose derivative is increased, interaction with the plasticizer is increased, and thus bleed-out of the plasticizer is prevented. In addition, since the interaction between substituents does not become too strong, and the decrease of mobility of molecules is prevented, hydrogen bonds between molecules easily occur, and elastic modulus and heat resistance are further increased.

The substitution degree of the specific cellulose derivative is preferably in the range of 1.8 to 2.5, more preferably in the range of 2 to 2.5, and particularly preferably in the range of 2.2 to 2.5. If the substitution degree is 1.8 or greater, interaction between molecules does not become too small, and the plasticization is prevented, such that the elastic modulus and the heat resistance are further increased.

In addition, the substitution degree is an index indicating a degree of acylation of a cellulose derivative. Specifically, the substitution degree means an intramolecular average of the number of substitutions in which three hydroxyl groups included in a D-glucopyranose unit of the cellulose derivative are substituted with an acyl group.

Synthesis Method

A method of preparing the cellulose derivative used in the exemplary embodiment is not particularly limited, and well-known methods are employed.

Hereinafter, a method of preparing a cellulose derivative in which the weight average molecular weight is 10,000 or greater and less than 75,000 and at least one hydroxyl group of the cellulose is substituted with an acyl group having 1 to 6 carbon atoms is described.

Adjustment of molecular weight of cellulose First, cellulose before acylation, that is, cellulose of which a hydroxyl group is not substituted with an acyl group, is prepared and the molecular weight thereof is adjusted.

As the cellulose before acylation, cellulose prepared arbitrarily may be used or commercially available cellulose may be used. Incidentally, the cellulose is usually a resin derived from plants, and the weight average molecular weight thereof is generally higher than that of the specific cellulose derivative according to the exemplary embodiment. Therefore, the adjustment of the molecular weight of the cellulose generally includes a step for decreasing the molecular weight.

For example, the weight average molecular weight of the commercially available cellulose is generally in the range of 150,000 to 500,000.

As the commercially available cellulose before acylation, for example, KC Flock (W50, W100, W200, W300G, W400G, W-100F, W60MG, W-50GK, and W-100GK), NDPT, NDPS, LNDP, and NSPP-HR manufactured by Nippon Paper Industries Co., Ltd. are included.

A method of adjusting a molecular weight of the cellulose before acylation is not particularly limited, but for example, there is a method of decreasing the molecular weight by stirring the cellulose in liquid.

By adjusting the speed and the time for the stirring of the cellulose is stirred, the molecular weight of the cellulose may be adjusted to a desired value. In addition, though not particularly limited, the stirring speed in stirring the cellulose is preferably in the range of 50 rpm to 3,000 rpm, and more preferably in the range of 100 rpm to 1,000 rpm. In addition, the stirring time is preferably in the range of 2 hours to 48 hours, and more preferably in the range of 5 hours to 24 hours.

In addition, as the liquid used when the cellulose is stirred, an aqueous solution of hydrochloric acid, an aqueous solution of formic acid, an aqueous solution of acetic acid, an aqueous solution of nitric acid, and an aqueous solution of sulfuric acid are exemplified.

Preparation of Cellulose Derivative

The cellulose of which the molecular weight is adjusted by the methods described above is acylated with an acyl group having 1 to 6 carbon atoms by a well-known method, to thereby obtain a cellulose derivative.

For example, for the case where at least one hydroxyl group included in the cellulose is substituted with an acetyl group, a method of esterifying the cellulose by using a mixture of acetic acid, acetic anhydride, and sulfuric acid is exemplified. In addition, for the case where at least one hydroxyl group included in the cellulose is substituted with a propionyl group, a method of performing esterification by using propionic anhydride in substitution for the acetic anhydride in the above mixture is exemplified, for the case where at least one hydroxyl group included in the cellulose is substituted with a butanoyl group, a method of performing esterification by using butyric anhydride in substitution for the acetic anhydride in the above mixture is exemplified, and for the case where at least one the hydroxyl group included in the cellulose is substituted with a hexanoyl group, a method of performing esterification by using hexanoic anhydride in substitution for the acetic anhydride in the above mixture is exemplified.

After acylation, in order to adjust the substitution degree, a deacylation step may be further performed. In addition, after the acylation step or the deacylation step, a step of further refining the cellulose may be preformed.

Ratio of Cellulose Derivative Occupied in Resin Composition

The ratio occupied by the cellulose derivative with respect to the total amount of the resin composition according to the exemplary embodiment is preferably 70% by weight or more, more preferably 80% by weight or more. If the ratio is 70% by weight or greater, an elastic modulus is increased, and also heat resistance becomes higher.

Plasticizer

The resin composition according to the exemplary embodiment further contains a plasticizer. The plasticizer is not particularly limited, and preferably has a hydrophilic group. If the plasticizer has a hydrophilic group, the interaction with the hydroxyl group or the hydrogen bond included in the cellulose derivative is increased, and the bleed-out of the plasticizer is prevented.

For example, as the hydrophilic group, a hydroxyl group, a carbonyl group, a phosphate group, a sulfo group, ether, ester, and an amino group are included.

Among these, a hydroxyl group, a carbonyl group, a phosphate group, and ester are more preferable, and a hydroxyl group, a carbonyl group, and a phosphate group are more preferable.

As a plasticizer, for example, an adipic acid ester-containing compound, a polyether ester compound, a phosphoric acid ester compound, metallic soap, a sebacic acid ester compound, a glycol ester compound, an acetic acid ester, dibasic acid ester compound, a phthalic acid ester compound, camphor, citric acid ester, stearic acid ester, polyol, and polyalkylene oxide are included.

Among these, in view of preventing the bleed-out of the plasticizer, an adipic acid ester-containing compound, a polyether ester compound, a phosphoric acid ester compound, and a metallic soap are preferable, and an adipic acid ester-containing compound is more preferable.

Adipic Acid Ester-Containing Compound

An adipic acid ester-containing compound (compound containing adipic acid ester) refers to a compound of individual adipic acid esters, and a mixture of adipic acid ester and components other than adipic acid ester (compound different from adipic acid ester). However, the adipic acid ester-containing compound may preferably contain the adipic acid ester by 50% by weight or more with respect to the total of adipic acid ester and other components.

As the adipic acid ester, for example, an adipic acid diester, and an adipic acid polyester are exemplified. Specifically, an adipic acid diester represented by the formula (2-1) and an adipic acid polyester represented by the formula (2-2) are exemplified.

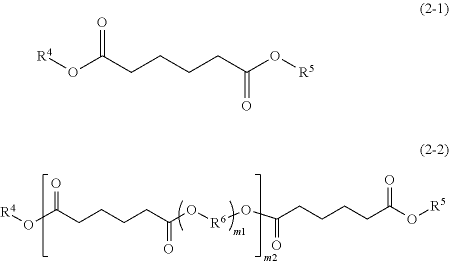

In the formulae (2-1) and (2-2), R⁴ and R⁵ each independently represents an alkyl group, or a polyoxyalkyl group [—(CₓH₂ₓ—O)_{y}—R^{A1}] (provided that R^{A1} represents an alkyl group, x represents an integer in the range of 1 to 10, and y represents an integer in the range of 1 to 10).

R⁶ represents an alkylene group.

m1 represents an integer in the range of 1 to 20.

m2 represents an integer in the range of 1 to 10.

In the formulae (2-1) and (2-2), the alkyl groups represented by R⁴ and R⁵ are preferably alkyl groups having 1 to 6 carbon atoms, and more preferably alkyl groups having 1 to 4 carbon atoms. The alkyl groups represented by R⁴ and R⁵ may have any one of a linear shape, a branched shape, or a cyclic shape, but preferably a linear shape and a branched shape.

In the formulae (2-1) and (2-2), in the polyoxyalkyl group represented by R⁴ and R⁵ [—(CₓH₂ₓ—O)_{y}—R^{A1}], the alkyl group represented by R^{A1} is preferably an alkyl group having 1 to 6 carbon atoms, and more preferably an alkyl group having 1 to 4 carbon atoms. The alkyl group represented by R^{A1} may have any one of a linear shape, a branched shape, or a cyclic shape, but preferably a linear shape and a branched shape.

In the formula (2-2), the alkylene group represented by R⁶ is preferably an alkylene group having 1 to 6 carbon atoms, and more preferably an alkylene group having 1 to 4 carbon atoms. The alkylene group represented by R⁶ may have any one of a linear shape, a branched shape, or a cyclic shape, but preferably a linear shape and a branched shape.

In the formulae (2-1) and (2-2), the group represented by each of R⁴ to R⁶ may be substituted with a substituent. As the substituent, an alkyl group, an aryl group, and a hydroxyl group are exemplified.

The molecular weight of the adipic acid ester (or weight average molecular weight) is preferably in the range of 200 to 5,000, and more preferably in the range of 300 to 2,000. The weight average molecular weight is a value measured according to the method of measuring the weight average molecular weight of the cellulose derivative described above.

Specific examples of the adipic acid ester-containing compound are described below, but the invention is not limited thereto.

| | Name of Material | Name of Product | Manufacturer |
|---|---|---|---|
| ADP1 | Adipic acid | Daifatty 101 | Daihachi Chemical |
| | diester | | Industry Co., Ltd. |
| ADP2 | Adipic acid | Adeka Cizer RS-107 | ADEKA Corporation |
| | diester | | |
| ADP3 | Adipic acid | Polycizer W-230-H | DIC Corporation |
| | polyester | | |

Polyether Ester Compound

As the polyether ester compound, or example, a polyether ester compound represented by the formula (2) is exemplified.

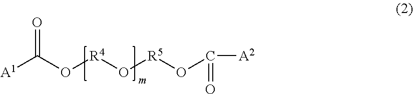

In the formula (2), R⁴ and R⁵ each independently represents an alkylene group having 2 to 10 carbon atoms. A¹ and A² each independently represents an alkyl group having 1 to 6 carbon atoms, an aryl group having 6 to 12 carbon atoms, or an aralkyl group having 7 to 18 carbon atoms. m represents an integer of 1 or greater.

In the formula (2), as the alkylene group represented by R⁴, an alkylene group having 3 to 10 carbon atoms is preferable, and an alkylene group having 3 to 6 carbon atoms is more preferable. The alkylene group represented by R⁴ may have any one of a linear shape, a branched shape, or a cyclic shape, but preferably a linear shape.

If the number of carbons of the alkylene group represented by R⁴ is set to be 3 or greater, the decrease of the fluidity of the resin composition is prevented, and thermoplasticity is easily exhibited. If the number of carbons of the alkylene group represented by R⁴ is 10 or lower or the alkylene group represented by R⁴ has a linear shape, the affinity to the cellulose derivative is easily enhanced. Therefore, if the alkylene group represented by R⁴ has a linear shape and the number of carbons is in the range described above, moldability of the resin composition is enhanced.

In this point of view, particularly, the alkylene group represented by R⁴ is preferably a n-hexylene group (—(CH₂)₆—). That is, the polyether ester compound is preferably a compound where R⁴ represents a n-hexylene group (—(CH₂)₆—).

In the formula (2), as the alkylene group represented by R⁵, an alkylene group having 3 to 10 carbon atoms is preferable, and an alkylene group having 3 to 6 carbon atoms is more preferable. The alkylene group represented by R⁵ may have any one of a linear shape, a branched shape, or a cyclic shape, but preferably a linear shape.

If the number of carbons of the alkylene group represented by R⁵ is 3 or greater, the decrease of the fluidity of the resin composition is prevented and the thermoplasticity is easily exhibited. If the number of carbons of the alkylene group represented by R⁵ is 10 or lower or if the alkylene group represented by R⁵ has a linear shape, the affinity to the cellulose derivative is easily enhanced. Therefore, if the alkylene group represented by R⁵ has a linear shape and the number of carbons is in the range described above, moldability of the resin composition is enhanced.

In this point of view, particularly, the alkylene group represented by R⁵ is preferably a n-butylene group (—(CH₂)₄—). That is, the polyether ester compound is preferably a compound where R⁵ represents a n-butylene group (—(CH₂)₄—).

In the formula (2), the alkyl group represented by A¹ or A² is an alkyl group having 1 to 6 carbon atoms, preferably an alkyl group having 2 to 4 carbon atoms. The alkyl group represented by A¹ or A² may have any one of a linear shape, a branched shape, or a cyclic shape, but preferably has a branched shape.

The aryl group represented by A¹ of A² is an aryl group having 6 to 12 carbon atoms, and as examples thereof, an unsubstituted aryl group such as a phenyl group and a naphthyl group and a substituted phenyl group such as a t-butylphenyl group and a hydroxyphenyl group are exemplified.

The aralkyl group represented by A¹ or A² is a group represented by —R^{A}-Ph. R^{A} represents a linear-shaped or branched alkylene group having 1 to 6 carbon atoms (preferably, having 2 to 4 carbon atoms). Ph represents an unsubstituted phenyl group or a substituted phenyl group which is substituted with the linear-shaped or branched alkyl group having 1 to 6 carbon atoms (preferably, having 2 to 6 carbon atoms). As the aralkyl group, specifically, for example, an unsubstituted aralkyl group such as a benzil group, a phenylmethyl group (phenethyl group), a phenylpropyl group, and a phenylbutyl group, and a substituted aralkyl group such as a methylbenzil group, a dimethylbenzil group, and a methylphenethyl group are exemplified.

At least one of A¹ and A² preferably represents an aryl group or an aralkyl group. That is, the polyether ester compound is preferably a compound where at least one of A¹ and A² represents an aryl group (preferably, phenyl group) or an aralkyl group, and preferably a compound where both of A¹ and A² represent an aryl group (preferably, phenyl group) or an aralkyl group.

Subsequently, characteristics of the polyether ester compound are described.

The weight average molecular weight (Mw) of the polyether ester compound is preferably in the range of 450 to 650, and more preferably in the range of 500 to 600.

If the weight average molecular weight (Mw) is 450 or greater, bleeding (phenomenon of deposition) becomes difficult. If the weight average molecular weight (Mw) is 650 or lower, the affinity to the cellulose derivative is easily enhanced. Therefore, if the weight average molecular weight (Mw) is in the range described above, moldability of the resin composition is enhanced.

In addition, the weight average molecular weight (Mw) of the polyether ester compound is a value measured by gel permeation chromatography (GPC). Specifically, the measurement of the molecular weight by GPC is performed by using HPLC1100 manufactured by Tosoh corporation as a measurement device, and TSKgel GMHHR-M+TSKgel GMHHR-M (7.8 mm I.D. 30 cm) which is a column manufactured by Tosoh Corporation, with a chloroform solvent. Also, the weight average molecular weight is calculated by using a molecular weight calibration curve obtained by a monodispersed polystyrene standard sample from the measurement result.

The viscosity of the polyether ester compound at 25° C. is preferably in the range of 35 mPa·s to 50 mPa·s, and more preferably in the range of 40 mPa·s to 45 mPa·s.

If the viscosity is 35 mPa·s or greater, the dispersibility to the cellulose derivative is easily enhanced. If the viscosity is 50 mPa·s or lower, anisotropy of the dispersion of the polyether ester compound hardly appears. Therefore, if the viscosity is in the range described above, the moldability of the resin composition is enhanced.

In addition, the viscosity is a value measured by an E-type viscosmeter.

A solubility parameter (SP value) of the polyether ester compound is preferably in the range of 9.5 to 9.9, and more preferably in the range of 9.6 to 9.8.

If the solubility parameter (SP value) is in the range of 9.5 to 9.9, dispersibility to the cellulose derivative is easily enhanced.

The solubility parameter (SP value) is a value calculated by a Fedor method, and specifically, the solubility parameter (SP value) is, for example, calculated by the following equation in conformity with the description in Polym. Eng. Sci., vol. 14, p. 147 (1974).

SP value=√(Ev/v)=√(ΣΔei/ΣΔvi) Equation:

(In the equation, Ev: evaporation energy (cal/mol), v: molar volume (cm³/mol), Δei: evaporation energy of each atom or atom group, and Δvi: molar volume of each atom or atom group)

In addition, the solubility parameter (SP value) employs (cal/cm³)^{1/2} as a unit, but the unit is omitted in conformity with practice, and is described in a dimensionless manner.

Hereinafter, specific examples of the polyether ester compound are described, but the invention is not limited thereto.

| | | | | | | Viscosity | | |
|---|---|---|---|---|---|---|---|---|
| | R⁴ | R⁵ | A¹ | A² | Mw | (25° C.) | APHA | SP value |
| PEE1 | —(CH₂)₆— | —(CH₂)₄— | Phenyl group | Phenyl group | 550 | 43 | 120 | 9.7 |
| PEE2 | —(CH₂)₂— | —(CH₂)₄— | Phenyl group | Phenyl group | 570 | 44 | 115 | 9.4 |
| PEE3 | —(CH₂)₁₀— | —(CH₂)₄— | Phenyl group | Phenyl group | 520 | 48 | 110 | 10.0 |
| PEE4 | —(CH₂)₆— | —(CH₂)₂— | Phenyl group | Phenyl group | 550 | 43 | 115 | 9.3 |
| PEE5 | —(CH₂)₆— | —(CH₂)₁₀— | Phenyl group | Phenyl group | 540 | 45 | 115 | 10.1 |
| PEE6 | —(CH₂)₆— | —(CH₂)₄— | t-Butyl group | t-Butyl group | 520 | 44 | 130 | 9.7 |
| PEE7 | —(CH₂)₆— | —(CH₂)₄— | Phenyl group | Phenyl group | 460 | 45 | 125 | 9.7 |
| PEE8 | —(CH₂)₆— | —(CH₂)₄— | Phenyl group | Phenyl group | 630 | 40 | 120 | 9.7 |
| PEE9 | —(CH₂)₆— | —(CH₂)₄— | Phenyl group | Phenyl group | 420 | 43 | 135 | 9.7 |
| PEE10 | —(CH₂)₆— | —(CH₂)₄— | Phenyl group | Phenyl group | 670 | 48 | 105 | 9.7 |
| PEE11 | —(CH₂)₆— | —(CH₂)₄— | Phenyl group | Phenyl group | 550 | 35 | 130 | 9.7 |
| PEE12 | —(CH₂)₆— | —(CH₂)₄— | Phenyl group | Phenyl group | 550 | 49 | 125 | 9.7 |
| PEE13 | —(CH₂)₆— | —(CH₂)₄— | Phenyl group | Phenyl group | 550 | 32 | 120 | 9.7 |
| PEE14 | —(CH₂)₆— | —(CH₂)₄— | Phenyl group | Phenyl group | 550 | 53 | 105 | 9.7 |
| PEE15 | —(CH₂)₆— | —(CH₂)₄— | Phenyl group | Phenyl group | 550 | 43 | 135 | 9.7 |
| PEE16 | —(CH₂)₆— | —(CH₂)₄— | Phenyl group | Phenyl group | 550 | 43 | 105 | 9.7 |
| PEE17 | —(CH₂)₆— | —(CH₂)₄— | Phenyl group | Phenyl group | 550 | 43 | 150 | 9.7 |
| PEE18 | —(CH₂)₆— | —(CH₂)₄— | Phenyl group | Phenyl group | 550 | 43 | 95 | 9.7 |

Phosphoric Acid Ester Compound

As a phosphoric acid ester compound, phosphoric acid ester, condensed phosphoric acid ester, and the like are exemplified.

As the phosphoric acid ester, for example, trimethyl phosphate, triethyl phosphate, tributyl phosphate, tri(2-ethylhexyl) phosphate, tributoxyethyl phosphate, triphenyl phosphate, tricresyl phosphate, trixylenyl phosphate, tris(isopropylphenyl) phosphate, tris(phenyl phenyl) phosphate, trinaphthyl phosphate, cresyl diphenyl phosphate, xylenyl diphenyl phosphate, diphenyl(2-ethylhexyl) phosphate, di(isopropylphenyl) phenyl phosphate, monoisodecyl phosphate, 2-acryloyloxyethyl acid phosphate, 2-methacryloyloxyethyl acid phosphate, diphenyl-2-acryloyloxyethyl phosphate, diphenyl-2-methacryloyloxyethyl phosphate, melamine phosphate, dimelamine phosphate, melamine pyrophosphate, triphenylphosphine oxide, tricresyl phosphine oxide, diphenyl methane phosphonate, and diethyl phenylphosphonate are exemplified.

As the condensed phosphoric acid ester, for example, an aromatic condensed phosphoric acid ester such as biphenol A-type ester, biphenylene-type ester, and isophthalic-type ester are included. Specifically, for example, a condensed phosphoric acid ester represented by the formula (A) and a condensed phosphoric acid ester represented by the formula (B) are included.

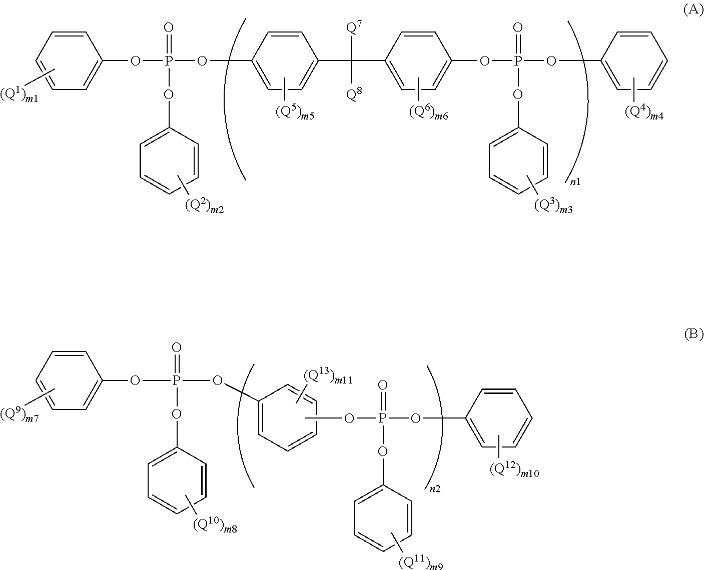

In the formula (A), Q¹, Q², Q³ and Q⁴ each independently represent an alkyl group having 1 to 6 carbon atoms, Q⁵ and Q⁶ each represent a methyl group, Q⁷ and Q⁸ each independently represent a hydrogen atom or a methyl group, m1, m2, m3, and m4 each independently represent an integer in the range of 0 to 3, m5 and m6 each independently represent an integer in the range of 0 to 2, and n1 represents an integer in the range of 0 to 10.

In the formula (B), Q⁹, Q¹⁰, Q¹¹, and Q¹² each independently represent an alkyl group having 1 to 6 carbon atoms, Q¹³ represents a methyl group, m7, m8, m9, and m10 each independently represent an integer in the range of 0 to 3, m11 represents an integer in the range of 0 to 4, and n2 represents an integer in the range of 0 to 10.

The phosphoric acid ester may be a synthesized product, or a commercially available product. As the commercially available product of the phosphoric acid ester, for example, “PX200”, “PX201”, “PX202”, and “CR741” which are commercially available products manufactured by Daihachi Chemical Industry Co., Ltd. and “Adeka Stab FP2100” and “Adeka Stab FP2200” manufactured by Adeka Corporation.

Metallic Soap

The metallic soap is a compound composed of a cation component being a univalent or polyvalent metal and an anion component being an organic acid component.

As the metal forming the metallic soap, lithium, magnesium, calcium, barium, zinc, and the like are included.

As the acid forming the metallic soap, stearic acid, lauric acid, ricinoleic acid, octyl acid, and the like are included.

As preferable examples of the metallic soap, lithium stearate, magnesium stearate, calcium stearate, zinc stearate, calcium laurate, calcium ricinoleate, and the like are included. Among these, calcium stearate, magnesium stearate, and calcium ricinoleate are more preferable.

In addition, the content of the plasticizer is preferably such an amount that the ratio of the specific cellulose derivative occupied in a total amount of a resin composition is in the range described above. More specifically, the ratio of the plasticizer occupied in a total amount of a resin composition is preferably 30% by weight or lower, and more preferably 10% by weight. It is preferable that a ratio of the plasticizer occupied in a total amount of the resin composition is in a range of 5% by weight to 30% by weight. If the ratio of the plasticizer is in the range described above, the bleed-out of the plasticizer is prevented. In addition, the elastic modulus is further increased and the heat resistance is further enhanced.

Other Components

The resin composition according to the exemplary embodiment may contain other components in addition to the components described above, if necessary. As the other components, for example, a flame retardant, a compatibilizer, an antioxidant, a release agent, a light resistant agent, a weather resistant agent, a colorant, pigments, a modifier, a drip preventing agent, an antistatic agent, a hydrolysis inhibitor, a filler, and a reinforcing agent (glass fiber, carbon fiber, talc, clay, mica, glass flake, milled glass, glass bead, crystalline silica, alumina, silicon nitride, aluminum nitride, boron nitride, and the like) are exemplified. The content of the respective components is in the range of 0% by weight to 5% by weight with respect to the total amount of the resin composition. Here, the expression “0% by weight” means not including other components.

The resin composition according to the exemplary embodiment may contain other resins in addition to the resin described above. However, the other resins are included in such an amount that the ratio of the cellulose derivative occupied in the total amount of the resin composition becomes in the range described above.

As the other resins, for example, the thermoplastic resins which are well-known in the art are included. Specifically, polycarbonate resin; polypropylene resin; polyester resin; a polyolefin resin; polyester carbonate resin; a polyphenylene ether resin; polyphenylene sulfide resin; a polysulfone resin; polyether sulfone resin; a polyarylene resin; a polyetherimide resin; a polyacetal resin; a polyvinyl acetal resin; a polyketone resin; a polyetherketone resin; a polyetheretherketone resin; a polyarylketone resin; a polyether nitrile resin; a liquid crystal resin; a polybenzimidazole resin; polyparabanic acid resin; a vinyl-based polymer or a vinyl-based copolymer resin obtained by polymerizing or copolymerizing one or more vinyl monomers selected from the group consisting of an aromatic alkenyl compound, a methacrylic acid ester, acrylic acid ester, and a vinyl cyanide compound; a diene-aromatic alkenyl compound copolymer resin; a vinyl cyanide-diene-aromatic alkenyl compound copolymer resin; an aromatic alkenyl compound-diene-vinyl cyanide-N-phenylmaleimide copolymer resin; a vinyl cyanide-(ethylene-diene-propylene (EPDM))-aromatic alkenyl compound copolymer resin; a vinyl chloride resin; and a chlorinated vinyl chloride resin are exemplified. These resins may be used singly, or two or more types thereof may be used in combination.

Method of Preparing Resin Composition

The resin composition according to the exemplary embodiment is prepared, for example, by melting and kneading the mixture of the cellulose derivative and the components described above. In addition, the resin composition according to the exemplary embodiment is prepared by dissolving the components in a solvent. As a melting and kneading unit, well known units are included, and specifically, for example, a twin screw extruder, a Henschel mixer, a Banbury mixer, a single screw extruder, a multi-screw extruder, and a co-kneader are included.

In addition, the temperature at the time of kneading may be determined according to the melting temperature of the cellulose derivative used, but in view of the thermal decomposition and the fluidity, the temperature in the range of 140° C. to 240° C. is preferable, and the temperature in the range of 160° C. to 200° C. is more preferable.

Resin Molded Article

The resin molded article according to the exemplary embodiment includes the resin composition according to the exemplary embodiment. That is, the resin molded article according to the exemplary embodiment is composed of the same composition as the resin composition according to the exemplary embodiment.

Specifically, the resin molded article according to the exemplary embodiment may be obtained by molding the resin composition according to the exemplary embodiment. As the molding method, injection molding, extrusion molding, blow molding, heat press molding, calendaring molding, coating molding, cast molding, dipping molding, vacuum molding, transfer molding and the like may be applied.

As the method of molding the resin molded article according to the exemplary embodiment, since degrees of freedom in shape are high, injection molding is preferable. With respect to injection molding, the resin composition is heated and melted, casted into a mold, and solidified, so as to obtain a molded article. The resin composition may be molded by injection compression molding.

The cylinder temperature of the injection molding is, for example, in the range of 140° C. to 240° C., preferably in the range of 150° C. to 220° C., and more preferably in the range of 160° C. to 200° C. The mold temperature of the injection molding is, for example, in the range of 30° C. to 120° C., and more preferably in the range of 40° C. to 80° C. The injection molding may be performed, for example, by using a commercially available apparatus such as NEX500 manufactured by Nissei Plastic Industrial Co., Ltd., NEX150 manufactured by Nissei Plastic Industrial Co., Ltd., NEX70000 manufactured by Nissei Plastic Industrial Co., Ltd., and SE50D manufactured by Toshiba Machine Co., Ltd.

The resin molded article according to the exemplary embodiment may be appropriately used for the purposes of electric and electronic apparatuses, business machines, home appliances, automobile interior materials, engine covers, car bodies, containers, and the like. More specifically, the resin molded article may be used in housings of electric and electronic apparatuses or home appliances; various components of electric and electronic apparatuses or home appliances; interior components of automobiles; storage cases of CD-ROM, DVD, and the like; food containers; drink bottles; food trays; wrapping materials; films; and sheets.

### Examples

Hereinafter, the invention is described in greater detail with reference to examples, but the invention is not limited to the examples. In addition, unless described otherwise, the expression “part” refers to “part by weight”.

Preparation of Cellulose

2 kg of cellulose (KC Flock W50 manufactured by Nippon Paper Industries Co., Ltd.) is put to 20 L of an aqueous solution of 0.1 M hydrochloric acid, and stirred at room temperature (25° C.). Celluloses having respective molecular weights are obtained with the stirring times shown in Table 1. Incidentally, EP-1800 (product name, manufactured by Shinto Scientific Co., Ltd.) is used as a stirring device, and the rotation speed at the time of stirring is set to 500 rpm.

The weight average molecular weight is measured with a GPC apparatus (manufactured by Tosoh corporation, HLC-8320GPC, Column: TSKgel α-M), by using a solution of dimethylacetamide/lithium chloride having a volume ratio of 90/10.

TABLE 1

| | Stirring time | Weight average |
|---|---|---|
| | (hr) | molecular weight |
| Compound 1 | 0.3 | 75,500 |
| Compound 2 | 1 | 57,800 |
| Compound 3 | 2 | 31,000 |
| Compound 4 | 3 | 10,300 |
| Compound 5 | 5 | 9,400 |

Preparation of Cellulose Derivative

Acetylation Step

Pretreatment activation is performed by spraying 1 kg of Compound 1 in Table 1, with 500 g of glacial acetic acid. Thereafter, a mixture of 3.8 kg of glacial acetic acid, 2.4 kg of acetic anhydride, and 80 g of sulfuric acid is added, and esterification of Compound 1 is performed while the mixture is stirred and mixed at a temperature of 40° C. or lower. Esterification is finished when fiber fragments disappear.

Deacetylation Step

2 kg of acetic acid and 1 kg of water are added to the mixture, and stirred for 2 hours at room temperature (25° C.)

Refinement Step

Further, this solution is slowly dripped to a solution obtained by dissolving 20 kg of sodium hydroxide in 40 kg of water while the solution is stirred. The obtained white precipitate is suction-filtered and washed with 60 kg of water, to thereby obtain a cellulose derivative (Compound 6).

Cellulose derivatives (Compounds 7 to 10) are obtained in the same manner as described above except for changing Compound 1 to Compounds 2 to 5.

A cellulose derivative (Compound 11) is obtained in the same manner as described above except for using Compound 3 performing a refinement step immediately after an acetylation step is finished.

Cellulose derivatives (Compounds 12 to 16) are obtained in the same manner as described above except for using Compound 3 changing stirring time in deacetylation steps to 0.5 hours, 1 hour, 3 hours, 5 hours, and 10 hours, respectively.

Cellulose derivatives (Compounds 17 to 19) are obtained in the same manner as described above except for using Compound 3 and changing 2.4 kg of acetic anhydride in an acetylation step to 2 kg of propionic anhydride/0.3 kg of acetic anhydride and 1.8 kg of n-butyric anhydride/6 kg of acetic anhydride and 0.5 kg of n-hexanoic anhydride, respectively.

Weight average molecular weights are obtained in the same manner as in Compound 1, and substitution degrees are obtained with H¹-NMR measurement (JNM-ECZR manufactured by JEOL Ltd.).

The results are collectively shown in Table 2.

TABLE 2

| | Weight average | | Substitution |
|---|---|---|---|
| | molecular weight | Substituent | degree |
| Compound 6 | 79,800 | Acetyl | 2.15 |
| Compound 7 | 63,300 | Acetyl | 2.22 |
| Compound 8 | 38,800 | Acetyl | 2.25 |
| Compound 9 | 11,000 | Acetyl | 2.21 |
| Compound 10 | 9,900 | Acetyl | 2.19 |
| Compound 11 | 42,300 | Acetyl | 2.78 |
| Compound 12 | 40,500 | Acetyl | 2.59 |
| Compound 13 | 39,000 | Acetyl | 2.48 |
| Compound 14 | 37,000 | Acetyl | 1.65 |
| Compound 15 | 36,100 | Acetyl | 0.38 |
| Compound 16 | 35,800 | Acetyl | 0.25 |
| Compound 17 | 42,500 | n-propionyl/ | 2.05/0.35 |
| | | acetyl | |
| Compound 18 | 44,300 | n-butanoyl/ | 1.88/0.55 |
| | | acetyl | |
| Compound 19 | 36,000 | n-hexanoyl | 0.55 |

A cellulose ester-based resin composition obtained in Example 1 (paragraph [0119] to [0121], and [0129]) of JP-A-2006-299012 is referred to as Compound 20.

TABLE 3

| | | Weight | |
|---|---|---|---|
| | Example in | average | |
| | JP-A-2006- | molecular | |
| | 299012 | weight | Composition |
| Compound | 1 | 140,000 | Cellulose acetate: 72 parts |
| 20 | | | TPP: 24 parts |
| | | | Stearyl ketene dimer: 3 parts |
| | | | Stabilizer and the like: 1.02 parts |

Preparing of Pellets

Kneading is performed with a twin screw kneading apparatus (TEX41SS manufactured by Toshiba Machine Co., Ltd.) at kneading temperatures in mixing ratio compositions shown in Table 4 with respect to Examples 1 to 19 and Comparative Examples 1 to 3, so as to obtain respective resin composition pellets.

TABLE 4

| | Composition ratio | | | Kneading |
|---|---|---|---|---|
| | Cellulose derivative | | Plasticizer | temperature |
| | (parts) | | (parts) | (° C.) |
| Example 1 | Compound 7 (90) | | Compound 31 (10) | 190 |
| Example 2 | Compound 8 (95) | | Compound 31 (5) | 185 |
| Example 3 | Compound 8 (90) | | Compound 31 (10) | 180 |
| Example 4 | Compound 8 (70) | | Compound 31 (30) | 160 |
| Example 5 | Compound 9 (90) | | Compound 32 (10) | 170 |
| Example 6 | Compound 11 (90) | | Compound 31 (10) | 170 |
| Example 7 | Compound 12 (90) | | Compound 31 (10) | 180 |
| Example 8 | Compound 13 (90) | | Compound 31 (10) | 180 |
| Example 9 | Compound 14 (90) | | Compound 31 (10) | 180 |
| Example 10 | Compound 15 (90) | | Compound 31 (10) | 190 |
| Example 11 | Compound 16 (90) | | Compound 31 (10) | 190 |
| Example 12 | Compound 17 (90) | | Compound 31 (10) | 150 |
| Example 13 | Compound 18 (90) | | Compound 31 (10) | 150 |
| Example 14 | Compound 19 (90) | | Compound 31 (10) | 160 |
| Example 15 | Compound 7 (70) | Compound 30 (20) | Compound 31 (10) | 195 |
| Example 16 | Compound 8 (70) | Compound 30 (20) | Compound 31 (10) | 185 |
| Example 17 | Compound 8 (90) | | Compound 32 (10) | 185 |
| Example 18 | Compound 8 (85) | | Compound 33 (15) | 185 |
| Example 19 | Compound 8 (80) | | Compound 34 (20) | 185 |
| Comparative | Compound 6 (90) | | Compound 31 (10) | 190 |
| Example 1 | | | | |
| Comparative | Compound 10 (90) | | Compound 31 (10) | 160 |
| Example 2 | | | | |
| Comparative | Compound 20 (100) | | | 170 |
| Example 3 | | | | |

In addition, details of Compounds 30 to 34 presented in Table 4 are described below.

Cellulose Derivatives
Compound 30: Dimethyl cellulose (L40 manufactured by Daicel Corporation, weight average molecular weight of 140,000)

Plasticizer
Compound 31: Adipic acid ester mixture (Daifatty101 manufactured by Daihachi Chemical Industry Co., Ltd.)
Compound 32: Polyether ester compound (Product name: RS-1000 manufactured by Adeka Corporation)
Compound 33: Phosphoric acid ester compound (Product name: CR741 manufactured by Daihachi Chemical Industry Co., Ltd.)
Compound 34: Calcium stearate (Product name: SC-100 manufactured by Sakai Chemical Industry Co., Ltd.)

Injection Molding

With the obtained pellets, ISO small rectangular plate test samples (rectangular plates having a length of 60 mm, a width of 60 mm and a thickness of 2 mm) are prepared at cylinder temperatures and mold temperatures presented in Table 5 using an injection molding machine (PNX40 manufactured by Nissei Plastic Industrial Co., Ltd.).

Bleed-Out Test

Characters are written on the obtained rectangular plate test samples with oil ink, and the rectangular plates are left under the condition of 65° C./90 RH % for 1,000 hours. States on the test samples are evaluated based on the following standards.

A: No blur of characters in oil ink. No bleed-out of a plasticizer is seen visually.

B: Bleed-out is slightly seen, and characters in oil ink are slightly blur.

C: Blur of characters in oil ink is clearly generated, or bleed-out of a plasticizer is clearly seen visually.

TABLE 5

| | Molding condition | | | | |
|---|---|---|---|---|---|
| | Cylinder | Mold | Bleed-out test | | |
| | temperature | temperature | 100 | 500 | 1000 |
| | (° C.) | (° C.) | hr. | hr. | hr. |
| Example 1 | 190 | 60 | A | A | B |
| Example 2 | 185 | 60 | A | A | A |
| Example 3 | 180 | 60 | A | A | A |
| Example 4 | 160 | 60 | A | A | B |
| Example 5 | 170 | 60 | A | A | B |
| Example 6 | 170 | 60 | A | A | B |
| Example 7 | 180 | 60 | A | A | B |
| Example 8 | 180 | 60 | A | A | A |
| Example 9 | 180 | 60 | A | A | B |
| Example 10 | 190 | 60 | A | A | B |
| Example 11 | 190 | 60 | A | A | B |
| Example 12 | 150 | 60 | A | A | A |
| Example 13 | 150 | 60 | A | A | A |
| Example 14 | 160 | 60 | A | A | A |
| Example 15 | 195 | 60 | A | A | B |
| Example 16 | 185 | 60 | A | A | B |
| Example 17 | 185 | 60 | A | A | B |
| Example 18 | 185 | 60 | A | A | B |
| Example 19 | 185 | 60 | A | A | B |

| | | | | |
|---|---|---|---|---|
| Comparative | 190 | 60 | C | Test is not performed |
| Example 1 | | | | |
| Comparative | 160 | 60 | C | Test is not performed |
| Example 2 | | | | |
| Comparative | 170 | 60 | C | Test is not performed |
| Example 3 | | | | |

In the resin compositions according to the examples containing the cellulose derivative of which a weight average molecular weight is 10,000 or greater and less than 75,000, and in which at least one hydroxyl group is substituted with an acyl group having 1 to 6 carbon atoms and the plasticizer and the resin molded articles formed of the resin compositions, bleed-out is satisfactorily prevented compared with those in the comparative examples.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A resin composition comprising:
a cellulose derivative of which a weight average molecular weight is 10,000 or greater and less than 75,000 and in which at least one hydroxyl group is substituted with an acyl group having 1 to 6 carbon atoms; and
a plasticizer.

2. The resin composition according to claim 1,
wherein a substitution degree of the acyl group in the cellulose derivative is 2.5 or lower.

3. The resin composition according to claim 1,
wherein the plasticizer has a hydrophilic group.

4. The resin composition according to claim 2,
wherein the plasticizer has a hydrophilic group.

5. The resin composition according to claim 3,
wherein the hydrophilic group is at least one selected from the group consisting of a hydroxyl group, a carbonyl group, and a phosphate group.

6. The resin composition according to claim 4,
wherein the hydrophilic group is at least one selected from the group consisting of a hydroxyl group, a carbonyl group, and a phosphate group.

7. The resin composition according to claim 1,
wherein the plasticizer is an adipic acid ester-containing compound.

8. The resin composition according to claim 2,
wherein the plasticizer is an adipic acid ester-containing compound.

9. The resin composition according to claim 3,
wherein the plasticizer is an adipic acid ester-containing compound.

10. The resin composition according to claim 4,
wherein the plasticizer is an adipic acid ester-containing compound.

11. The resin composition according to claim 5,
wherein the plasticizer is an adipic acid ester-containing compound.

12. The resin composition according to claim 6,
wherein the plasticizer is an adipic acid ester-containing compound.

13. The resin composition according to claim 1,
wherein a ratio of the cellulose derivative occupied in a total amount of the resin composition is 70% by weight or greater.

14. The resin composition according to claim 2,
wherein a ratio of the cellulose derivative occupied in a total amount of the resin composition is 70% by weight or greater.

15. The resin composition according to claim 3,
wherein a ratio of the cellulose derivative occupied in a total amount of the resin composition is 70% by weight or greater.

16. The resin composition according to claim 5,
wherein a ratio of the cellulose derivative occupied in a total amount of the resin composition is 70% by weight or greater.

17. The resin composition according to claim 7,
wherein a ratio of the cellulose derivative occupied in a total amount of the resin composition is 70% by weight or greater.

18. The resin composition according to claim 1,
wherein a ratio of the plasticizer occupied in a total amount of the resin composition is in a range of 5% by weight to 30% by weight.

19. A resin molded article comprising the resin composition according to claim 1.

20. The resin molded article according to claim 19, which is molded by injection molding.
